(19) United States
(12) Patent Application Publication
(10) Pub. No.: US 2025/0384562 A1
(43) Pub. Date: Dec. 18, 2025

(54) METHOD FOR RECOGNIZING BIFURCATIONS IN A VASCULAR TREE, ASSOCIATED METHODS AND DEVICES

(71) Applicants: INSTITUT NATIONAL DE LA SANTE ET DE LA RECHERCHE MEDICALE, Paris (FR); CENTRE NATIONAL DE LA RECHERCHE SCIENTIFIQUE, Paris (FR); NANTES UNIVERSITÉ, Nantes (FR)

(72) Inventors: Florent AUTRUSSEAU, Nantes Cedex 3 (FR); Rafic NADER, Nantes Cedex 3 (FR)

(21) Appl. No.: 18/878,699

(22) PCT Filed: Jun. 26, 2023
(86) PCT No.: PCT/EP2023/067246

§ 371 Date: Dec. 24, 2024

(30) Foreign Application Priority Data
Jun. 27, 2022 (EP) 22305928.8

(51) Int. Cl. G06T 7/162

(52) U.S. Cl. CPC G06T 7/162; G06T 2207/20081; G06T 2207/30016; G06T 2207/30101

(57) ABSTRACT

The present invention concerns the field of analyzing the data contained in a vascular tree. For this, the present invention proposes using a smart modeling of bifurcations to generate proper synthetic data. Such synthetic data enables to form training sets of data for training an artificial intelligence algorithm adapted to recognize the bifurcations in a vascular tree. Such invention therefore enables to obtain a better recognition of the bifurcations. Such better recognition can advantageously be used in diagnostic, follow-up and prognostic methods.

### TECHNICAL FIELD OF THE INVENTION

The present invention concerns a method for recognizing at least one bifurcation of a vascular tree in a real image of a vascular tree of a subject. The invention concerns a method for predicting that a subject is at risk of developing an aneurysm. The invention also relates to a method for diagnosing an aneurysm. The invention also concerns a method for identifying a therapeutic target for preventing and/or treating an aneurysm. The invention also relates to a method for identifying a biomarker, the biomarker being a diagnostic biomarker of an aneurysm, a susceptibility biomarker of an aneurysm, a prognostic biomarker of an aneurysm or a predictive biomarker in response to the treatment of an aneurysm. The invention also concerns a method for screening a compound useful as a medicine, the compound having an effect on a known therapeutical target, for preventing and/or treating an aneurysm. The invention also relates to the associated computer program product and computer readable medium.

### BACKGROUND OF THE INVENTION

The cardiovascular system (also called circulatory system) is composed of all blood vessels (arteries, capillaries and veins) that carry blood and lymph through the entire human body. The purpose of this organ system is to transport nutrients, oxygen and carbon dioxide between body tissues. On certain organs, such as the heart, the liver, the kidneys, the lungs or the brain, the vascular system becomes denser. When reaching these organs, the arteries, capillaries or veins split into several branches, this forms a vascular tree.

The circulatory system may undergo various vascular diseases, such as atherosclerosis, blood clots, inflammation or some genetic diseases. Several factors, such as smoking habits, hypertension, cardio vascular history or some particular treatments may lead to a weakened vascular system. The vascular diseases may occur on various arteries of the human body and thus induce different effects (such as coronary artery disease, thoracic vascular disease and abdominal aortic aneurysms).

A weakened wall of the blood vessel may lead to the formation of an aneurysm. In the brain, aneurysms may take several forms, frequently as dissecting aneurysms (blood leaking out of the inner layer of the artery wall), fusiform aneurysms (local bulging of the artery characterized by a ballooning of the vessel, i.e. a local increase of the diameter), or saccular (sometimes called berry) aneurysms (a bulge occurring on a single side of the artery). Ninety percent of the cerebral aneurysms belong to this latter form.

Often an aneurysm may remain benign and never evolve into a dangerous state. The main complication induced by an aneurysm is when it does rupture, then blood will then escape into the surrounding tissues and provoke a sub-arachnoid hemorrhage that may lead to the death or a permanent disability. The rupture causes a decreased blood flow downstream, and thus, an ischemia. ICAs must be closely monitored, as the risk of rupture is prevalent: the risk of rupture is higher along a sub set of arteries located in the center of the brain called the “Circle of Willis”. Eighty-five percent of the saccular ICAs occur along the Circle of Willis. ICA aneurysms are quite prevalent, affecting 2 to 5 percent of the adult worldwide population. An ICA rupture happens to about 8-10/100.000 persons per year for the Caucasian population and to about 20/100.000 persons per year for Japanese or Finnish populations.

It is therefore desirable to detect such pathologies and notably cerebrovascular diseases, and more specifically on the formation of Intra Cranial Aneurysms (ICA).

Several works have been conducted on the vasculature segmentation or the aneurysms detection. Fewer works have been devoted to aneurysms segmentation, and even fewer focused on the bifurcation detection, but, no studies have been conducted on cerebral bifurcation recognition.

Due to the recent impressive advances attained on medical image analysis using Deep Learning methods, it naturally arises as the most obvious approach to tackle any of the previously cited tasks.

However, when it comes to Deep Learning method, manual annotations of unlabeled data are most often unavoidable. Commonly, the studies on segmentation or detection related to vasculature segmentation/detection resort to hundreds (at most) of manually segmented images to train the neural networks.

This leads to a set of data providing with an insufficient learning of the neural network. This neural network therefore exhibits poor performances, such as a poor robustness or an inaccurate prediction.

### SUMMARY OF THE INVENTION

The invention aims at providing a method for recognizing at least one bifurcation of a vascular tree in a real image of a vascular tree of a subject, which exhibits a better precision and a better robustness.

To this end, the specification describes a method for recognizing at least one bifurcation of a vascular tree in a real image of a vascular tree of a subject, notably a cerebral one, the method being computer-implemented, the method comprising:
a phase of generating synthetic images of at least one bifurcation of a vascular tree, the phase of generating comprising, for each synthetic image, the steps of:
   receiving a real image comprising at least one bifurcation of a vascular tree,
   modeling the real image by an imaging model with a specific set of values for a set of parameters, the imaging model comprising at least a geometrical model of the bifurcation,
   the geometrical model being a tridimensional model of the bifurcation and including a graph of the vascular tree, the graph being a set of nodes linked by branches with a weight, the geometrical model being obtained by segmenting the real image,
   generating the image corresponding to the imaging model with a modified set of
values, the generated image being the synthetic image,
a phase of training a recognition predictor adapted to obtain bifurcation recognition data in an input image, to obtain a trained recognition predictor, the phase of training comprising the steps of:
   forming a training dataset based on the synthetic images, and
   training the recognition predictor by using the training dataset, and
a phase of inferring, the phase of inferring comprising the steps of:
   receiving a real image to be analyzed, the real image to be analyzed being an image of the vascular tree of the subject, and
   applying the trained recognition predictor on the image to be analyzed to obtain bifurcation recognition data.

According to further aspects, which are advantageous but not compulsory, the method for recognizing might incorporate one or several of the following features, taken in any technically admissible combination:
the imaging model comprises a noise model, the noise model modelling the noise of the image by a Gaussian noise with a standard deviation, the standard deviation of the Gaussian noise being one of the parameters of the model, the standard deviation being equal to a first value,
during the step of generating, a Gaussian filter with a standard deviation is applied on the real image to obtain an image with a Gaussian noise with a standard deviation having a second value, the second value being different from the first value, the standard deviation of the Gaussian filter depending from the first value and the second value.
the parameters of geometrical model further include the diameters of the bifurcation, the values of the diameters being obtained by applying a convolution kernel on the real image.
during the step of generating, a geometrical distortion is applied to the geometrical model.
the geometrical model defines reference points for the bifurcation, the geometrical model comprising interpolating functions linking the reference points, each interpolating function being a function defined by coefficients, the coefficients being parameters of the set of parameters, the coefficients being modified during the step of generating.
each interpolating function is a B-spline function defined by B-spline's coefficients and the coefficients are the B-spline's coefficients.
the values of the coefficients are modified by adding a random value multiplied by a weight to the specific value.
the imaging model includes a background model, the background model comprising a shape with two distinct values.
each image is taken by a MRA-TOF technique.
the bifurcation recognition data are chosen among the following elements:
   the class or the type of bifurcation,
   the presence of the bifurcation,
   the location of the bifurcation,
   the bifurcation angle of the bifurcation,
   the geodesic distance between two bifurcations,
   the cross-section area of the detected bifurcation, and
   the tortuosity parameter of the bifurcation.
the recognition predictor is a neural network.
the neural network is a convolutional neural network.

The specification further relates to a method comprising carrying out the steps of a method for recognizing at least one bifurcation of a vascular tree in a real image of a vascular tree of a subject, the method being according to any one of claims 1 to 8, the method being chosen in the list consisting of
a method for predicting that a subject is at risk of developing an aneurysm, the method for predicting at least comprising the step of:
   carrying out the steps of the method for recognizing, to obtain bifurcation recognition data,
   predicting that the subject is at risk of developing the aneurysm based on the obtained bifurcation recognition data,
a method for diagnosing an aneurysm, the method for diagnosing at least comprising the step of:
   carrying out the steps of the method for recognizing, to obtain bifurcation recognition data, and
   diagnosing the aneurysm based on the obtained bifurcation recognition data,
a method for identifying a therapeutic target for preventing and/or treating an aneurysm, the method comprising at least the step of:
   carrying out the steps of the method for recognizing to a first subject, to obtain first obtained bifurcation recognition data, the first subject being a subject suffering from the aneurysm,
   carrying out the steps of the method for recognizing to a second subject, to obtain obtained bifurcation recognition data, the second subject being a subject not suffering from the aneurysm, and
   selecting a therapeutic target based on the comparison of the first and second obtained bifurcation recognition data,
a method for identifying a biomarker, the biomarker being a diagnostic biomarker of an aneurysm, a susceptibility biomarker of an aneurysm, a prognostic biomarker of an aneurysm or a predictive biomarker in response to the treatment of an aneurysm, the method comprising at least the step of:
   carrying out the steps of the method for recognizing to a first subject, to obtain first obtained bifurcation recognition data, the first subject being a subject suffering from the aneurysm,
   carrying out the steps of the method for recognizing to a second subject, to obtain second obtained bifurcation recognition data, the second subject being a subject not suffering from the aneurysm, and
   selecting a biomarker based on the comparison of the first and second determined parameters,
and
a method for screening a compound useful as a probiotic, a prebiotic or a medicine, the compound having an effect on a known therapeutical target, for preventing and/or treating an aneurysm, the method comprising at least the step of:
   carrying out the steps of the method for recognizing to a first subject, to obtain first obtained bifurcation recognition data, the first subject being a subject suffering from the aneurysm and having received the compound,
   carrying out the steps of the method for recognizing to a second subject, to obtain second obtained bifurcation recognition data, the second subject being a subject suffering from the aneurysm and not having received the compound, and
   selecting a compound based on the comparison of the first and second determined parameters.

The specification further relates to a computer program product comprising instructions for carrying out the steps of a method as previously described when said computer program product is executed on a suitable computer device.

The specification also relates to a computer readable medium having encoded thereon a computer program as previously described.

### BRIEF DESCRIPTION OF THE DRAWINGS

The invention will be better understood on the basis of the following description which is given in correspondence with the annexed figures and as an illustrative example, without restricting the object of the invention. In the annexed figures:

FIG. 1 shows schematically a system and a computer program product whose interaction enables to carry out a method for generating images of at least one bifurcation of a cerebral vascular tree,

FIG. 2 is an example of a flowchart illustrating an example of carrying out of an example of a method for recognizing at least one bifurcation of a vascular tree,

FIG. 3 is a schematic view of an example of bifurcation, and

FIG. 4 is a comparison between the artery of a real image and the artery of a synthetic image.

### DETAILED DESCRIPTION OF SOME EMBODIMENTS

### Description of the System

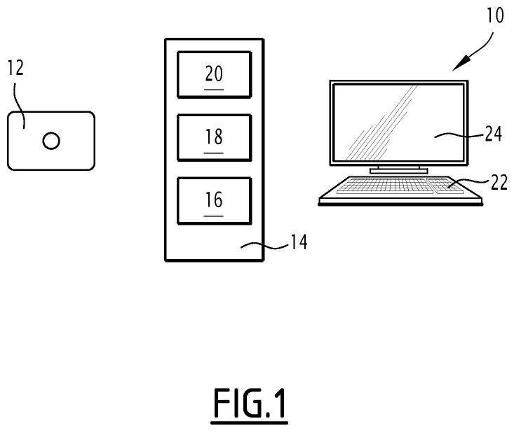

A system 10 and a computer program product 12 are represented in FIG. 1. The interaction between the computer program product 12 and the system 10 enables to carry out a method for recognizing at least one bifurcation of a vascular tree in a real image of a vascular tree of a subject.

System 10 is a computer. In the present case, system 10 is a laptop.

More generally, system 10 is a computer or computing system, or similar electronic computing device adapted to manipulate and/or transform data represented as physical, such as electronic, quantities within the computing system's registers and/or memories into other data similarly represented as physical quantities within the computing system's memories, registers or other such information storage, transmission or display devices.

System 10 comprises a processor 14, a keyboard 22 and a display unit 24.

The processor 14 comprises a data-processing unit 16, memories 18 and a reader 20.

The reader 20 is adapted to read a computer readable medium.

The computer program product 12 comprises a computer readable medium.

The computer readable medium is a medium that can be read by the reader of the processor. The computer readable medium is a medium suitable for storing electronic instructions, and capable of being coupled to a computer system bus.

Such computer readable storage medium is, for instance, a disk, a floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

A computer program is stored in the computer readable storage medium. The computer program comprises one or more stored sequence of program instructions.

The computer program is loadable into the data-processing unit and adapted to cause execution of the method for recognizing when the computer program is run by the data-processing unit.

### Operating of the System

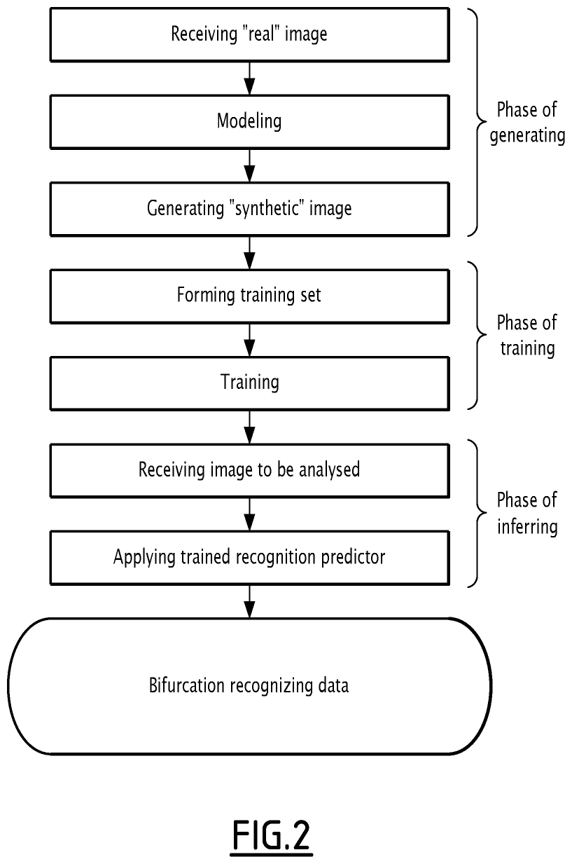

Operating of the system 10 is now described by illustrating an example of carrying out a method for recognizing at least one bifurcation of a vascular tree in a real image of a vascular tree of a subject as illustrated by the flowchart of FIG. 2.

Such method for recognizing aims at identifying at least one bifurcation of a vascular tree, namely localizing and/or characterizing it.

In the present example, it is assumed that the method for recognizing is dedicated to a classifying task.

More precisely, several kinds of bifurcations have been determined as interesting, because seemingly leading to an aneurysm and the method for recognizing searches to identify properly if the imaged bifurcation is one of these bifurcations of interest.

For instance, the number of kinds of bifurcations is comprised between 10 and 20.

A vascular tree is a set of blood arteries in an area. The cerebral vascular tree is the vascular tree of the brain of a subject.

It is to be noted that the cerebral vascular tree is only given as a specific example, bearing in mind that the method can be applied to any vascular tree.

It should also be mentioned that, contrary to many other methods belonging to the prior art, the method for recognizing which is detailed is able to handle three-dimensional vascular tree.

The subject is an animal, notably a mammal.

In particular, the subject is a mouse or a human being.

A bifurcation is a splitting of a mother artery into two or more daughter arteries.

In particular, it is not rare to find a trifurcation that is a splitting of a mother artery into three daughter arteries.

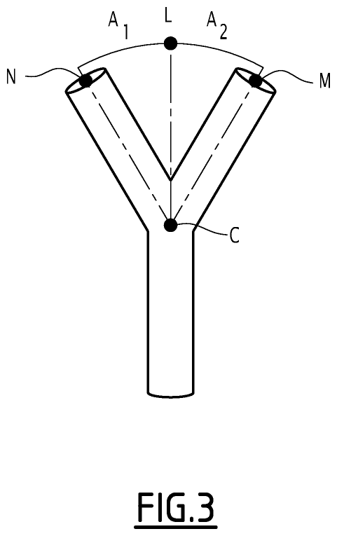

The meaning of bifurcation in what follows is either according to the context the splitting of a mother artery into two or more daughter arteries (meaning largo sensu) or the splitting of a mother artery into exactly two daughter arteries (meaning stricto sensu). A bifurcation is represented on FIG. 3.

It should be noted that, for clarity, only the use of the method for recognizing for one bifurcation is presented while keeping in mind that the method for recognizing is preferably applied for each bifurcation that exists in the cerebral vascular tree.

In addition, it is assumed that the bifurcation to which the method for recognizing is applied is a bifurcation which is located along the Circle of Willis. Indeed, this location is where 85% of the saccular intra-cranial aneurysms occur which results in a more precise prediction of aneurysm In the present example, the method for recognizing comprises three phases: a phase of generating, a phase of training and a phase of inferring.

During the phase of generating, the system 10 generates synthetic images of at least one bifurcation of a vascular tree.

For this, the system 10 carries out several steps for each synthetic image to be generated.

Here, the system 10 carries out a step of receiving, a step of modeling and a step of generating.

During the step for receiving, the system 10 receives at least one image comprising at least one bifurcation of the cerebral vascular tree.

Such image is named “real image” by opposition to the images that will be generated at the end of the phase for generating.

The image is an image of a brain of a subject and the image has been acquired by an imaging technique.

The imaging technique is, for instance, MRA-TOF technique. MRA stands for magnetic resonance angiography and TOF for time-of-flight.

However, other imaging techniques may be considered such as magnetic resonance imaging (MRI), digital subtraction angiography (DSA) or computed tomography angiography (CTA).

In any case, the images form a three dimensional (3D) images of the cerebral vascular tree.

At the step of modeling, the system 10 seeks to represent the real image by an imaging model with a specific set of values for a set of parameters.

In other words, the real image is represented by a model, which depends from parameters and the system 10 searches for the value of the parameters.

The idea is to generate the synthetic image by varying one or several of the parameters.

This implies that the model represents in a relatively accurate way the image and its content and that the parameters can be easily modified to obtain new images that will be realistic although synthetically generated.

For this, the model is here specifically chosen for this purpose.

As will be illustrated hereinafter, several models can be considered at this stage.

However, all these models at least share the feature according to which the imaging model comprises at least a geometrical model of the bifurcation. This geometrical model is a tridimensional model of the bifurcation and includes a graph of the vascular tree, the graph being a set of nodes linked by branches with a weight.

The geometrical model is obtained by extracting a tridimensional model of the bifurcation from the real image.

An example of operations enabling to carrying out a step for extracting the tridimensional model of the bifurcation is now described.

The step for extracting includes an operation of binarization of the images.

In such operation, a threshold is used to obtain voxels with an upper value (indicating the presence of blood) and a lower value (no element detected).

More generally, any other kind of segmentation operations can be considered here, and notably segmentation operations enables to class the voxels into more than two categories.

The step for extracting further includes an operation of skeletonization.

This operation consists in using an octree structure (a set of 3*3*3 pixels).

When the octree structure is full of voxels with an upper value, the voxels with an upper value linked to the octree structure are set as candidate for elimination.

The candidate voxels are then eliminated after testing that their removal does not affect the connectivity of the skeleton. In case, their removal does not keep the connectivity of the skeleton, the candidate voxels are not removed.

By iteratively repeating this operation and changing the position of the octree structure so as to sweep over all the image, a skeleton is obtained.

The step for extracting also comprises an operation of analyzing which is applied on the skeleton by using a second technique.

The second technique enables to obtain a connected and non-oriented graph of the vascular tree.

By definition, a graph is a set of nodes linked by branches.

The second technique consists in detecting the branches of the skeleton and setting that the extremities of each branch is a node.

At the end of the step for extracting, a tridimensional model of the bifurcation is thus obtained.

Several more elaborate imaging models can be considered.

As a first example, the parameters of geometrical model further includes the diameters of the bifurcation.

Arteries are made of various cellular layers. The innermost layer is called the tunica intima. The innermost layer is in direct contact with the blood flow.

The Applicants chose to define the arterial diameter as the artery diameter within the inner artery wall.

The system 10 obtains the value of the diameters by applying a convolution kernel on the real image.

In the present case, this means that the system 10 performs a convolution with a 3D spherical kernel on each and every branch. The applied sphere radius of the spherical kernel varies in order to model the various branches' diameters. As a second example, the geometrical model defines reference points for the bifurcation, the geometrical model comprising interpolating functions linking the reference points, each interpolating function being a function defined by coefficients, the coefficients being parameters of the set of parameters.

Such reference points are the 3D coordinates of the arteries' skeleton, namely the centerline of the 3D tubes obtained at the segmenting step.

The system 10 interpolates these reference points by any appropriate function. Notably, a perfectly linear branch would be obtained by fitting with a linear function.

As a specific example, the system 10 interpolates the bifurcation by B-spline functions. This means that the system 10 looks for fitting the centerlines using 3D spline functions.

B-spline functions can be represented by three different characteristics: the knot-points, defining the intervals of the chunks on which the polynomials are defined, the B-Splines′ (or polynomials′) coefficients, and the order of the spline, (i.e. the degree to which the fit was performed).

Here, the variable parameter of the B-spline functions are the B-spline's coefficients.

As a third example, the imaging model comprises a noise model, the noise model modelling the noise of the image by a Gaussian noise with a given average and a standard deviation.

In such a case, the standard deviation of the Gaussian noise is one of the parameters of the model.

So as to generate a plausible background noise, it is desirable to use Gaussian mixture models to collect the statistical properties of the surrounding noise, for instance on several images.

Such collection can be carried by collecting the properties in the images. This is relevant when it is decided to very precisely generate images.

Another means is to provide with the expected values. Such expected values can notably be determined by the kind of apparatus which enabled to obtain the image. A first kind of apparatus will correspond to a first set of expected values whereas a second kind of apparatus will correspond to a second set of expected values, the second set of expected values being different from the first set of expected values.

As a fourth example, the imaging model includes a background model, the background model comprising a shape with several distinct values.

More precisely, for a case with two values, the background model aims at modeling the various constituents of the brain, i.e., the white/gray matter, the Cerebro-Spinal Fluids (CSF), the ventricle or the Corpus Callosum.

These different elements within the brain, exhibit various radio-opacities, and hence various grey level intensities.

In the model, it is considered a two-material background noise. A darker matter (corresponding to the CSF, the ventricle and/or the Corpus Callosum) and a brighter matter (the white/gray matters). The creation of this dual background noise was performed via two steps.

First, the geometry of the darker part was modeled, for this task, the system 20 produces a strong distortion (using elastic deformations as described hereinafter) of the bifurcation shape, this heavily distorted pattern serving as a mask for the darker noise.

In the second step, all the voxels belonging neither to the dark noise portions and nor to the arteries were assigned to the brighter noise area. Proceeding this way forced the model to have the arteries immersed within the darker matters, which is actually where most of the arteries of the Circle of Willis can be found.

A synthetic aneurysm can also simply be modeled by composing a binary sphere that will be merged onto the binary bifurcation. The ICA will also endure geometric deformations, as in human brains, the ICA commonly exhibit higher level distortions. As for the spatial positioning of the ICA, we seek to place the ICA approximately onto the angle bisector. Thanks to a 3D graph extraction from the vasculature skeleton, the system 10 can collect the 3D directional vectors initiated at the bifurcation center and following each of the three arteries (bifurcations' branches).

Let us denote \vec{V}₁, \vec{V}₂ and \vec{V}₃ the three vectors initiated at a bifurcation center (3D graph node) and tangent to the 3 branches centerlines. If system 10 intends to embed an aneurysm in between branches 1 and 2, the system 10 must consider that the blood shall flow from branch 3 (mother branch). Indeed, saccular ICA typically occur on the arterial wall opposite to the mother branch, as the blood pressure will be more important on this portion of the bifurcation. \vec{V}₁+\vec{V}₂ being the bisector line for this angle, we want the aneurysm to have a better alignment with branch 3.

The system 10 positions the ICA as much as possible on the axis of the mother branch, and hence the system 10 computes the orientation that is along the orientation \vec{V}₀=\vec{V}₁+\vec{V}₂−2*\vec{V}₃. Once this orientation determined, the distance of the aneurysm along this line can be estimated.

The system 10 determines the distance D separating the bifurcation center to the aneurysm center (along V) using the following equation:

$$D = ( \frac{\overline{T}}{2} + r ) x ( 2 - \frac{{θ}_{12}}{π x ( 1 - \frac{1}{36} )} )$$

Where:
θ₁₂ is the angle formed by the branches #1 and #2,
T̅ is the average thickness of the 3 branches, and
r the aneurysm's radius.

The system 10 considers that the angles cannot be smaller than 5° (π/36 rad). This way, the smaller is the angle between the two branches, the further away will the ICA be embedded. On the opposite, for the largest angle configuration (180°), the ICA is approximately placed at

$$( \frac{\overline{T}}{2} + r )$$

voxels from the bifurcation center, i.e. the aneurysm is tangent to the bifurcation wall.

According to another embodiment, the distance D separating the bifurcation center to the aneurysm center is given by the following formula:

$$D = r + \sqrt{{( \frac{R}{tan ( \frac{Θ}{2} )} )}^{2} + {R}^{2}}$$

Where:
Θ stands for the angle formed by the two daughter arteries and is assumed here to be such that

$$Θ = \frac{{θ}_{12}}{2}$$

R is the average radius of the branches forming the bifurcation. R is thus equal to

$$\frac{\overline{T}}{2} .$$

In a more elaborate model, a growth parameter y is considered, the distance D thus becomes:

$$D = γ r + \sqrt{{( \frac{R}{tan ( \frac{Θ}{2} )} )}^{2} + {R}^{2}}$$

The growth parameter y is comprised between 0 and 1.

The use of a growth parameter enables to simulate different behaviours of the aneurysm.

Alternatively, if the distance D is defined as the distance from the center of the aneurysm to the joining point of the two branches (vessel wall), the expression becomes:

$$D = \frac{r}{sin ( \frac{Θ}{2} )} + \sqrt{{( \frac{R}{tan ( \frac{Θ}{2} )} )}^{2} + {R}^{2}}$$

Such calculations enable to automatically adjust the shift from the aneurysm center and the vessel wall where the daughter arteries split.

In variant, for each of the calculation of the distance D, the orientation may be determined as the bisector line \vec{V}₁+\vec{V}₂ instead of the orientation \vec{V}₀=\vec{V}₁+\vec{V}₂−2*\vec{V}₃.

It can easily be understood that the previous examples can be combined as desired to form new model.

Notably, one can consider a combination of the four previous examples to obtain the more detailed model.

During the step of generating, the system 10 generates the image corresponding to the imaging model with a modified set of values. The image that the system 10 generates is the synthetic image.

There again, depending on the imaging model, the step of generating will be carried out in a different way.

Some examples are given hereinafter for each example given at the step of modeling.

For the first example, during the step of generating, a geometrical distortion is applied to the geometrical model. This notably means that the geometrical distortion is not applied on the other models, and notably not the noise model.

For this, an elastic deformation can be applied, such as the ones that can be found in the ElasticDeform library (https://elasticdeform.readthedocs.io/).

Furthermore, it is also possible to apply various kernels (or more precisely various elastic deformations to the same kernel) along the vessel's centerline.

For the second example, when the geometrical model comprises interpolation functions and notably B-spline functions, the values of the coefficients are modified. Indeed, slightly altering the values of these parameter distort the position of the centerline coordinates.

Specifically, here, the system 10 alters the polynomials' coefficients. Once the vessels' centerlines have been tweaked via the spline function alteration, the system 10 collects the diameters of all arteries being accounted for within the 3D crop. Each centerline (morphological skeleton) being first tweaked by the spline alteration, can thus go through a convolution with a spherical kernel which size is adapted to the corresponding observed diameter. The system 10 then thickens each artery according to its measured anatomical property.

Such an approach allows to approximately control the artery's shape, but also to regulate its thickness and maintain a good balance between the various branches of a given bifurcation.

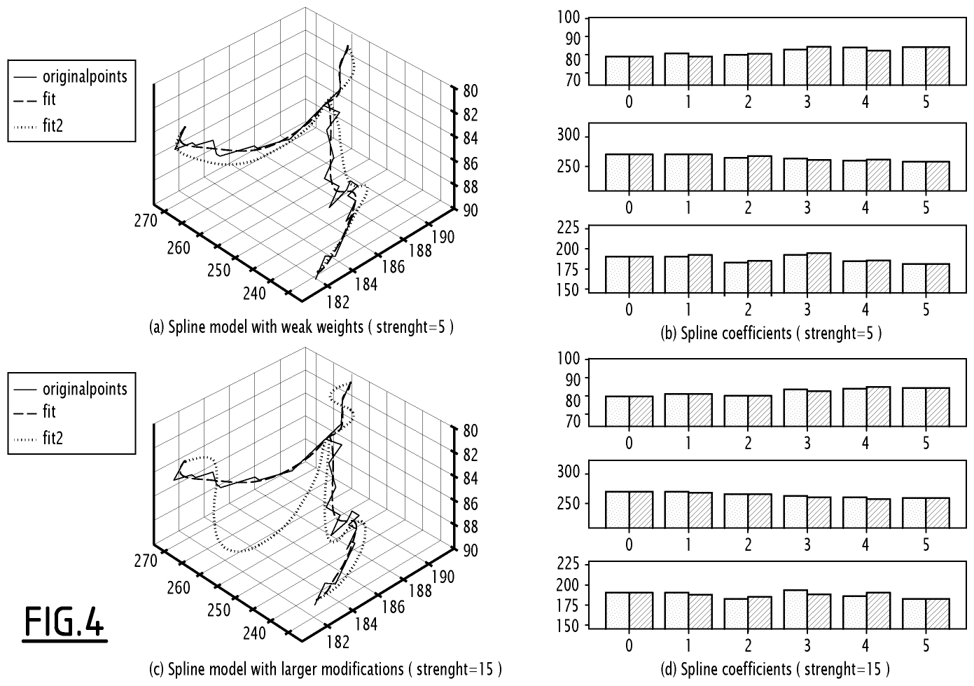

Examples of B-spline interpolation are represented on FIG. 4. The left panels show, for a given bifurcation, the 3D representation of three different aspects. The solid gray lines represent the actual coordinates of the bifurcation's branches, as collected within the MRA-TOF acquisition, the black dashed lines stand for the Spline functions that best represent the arteries, and finally, the black dotted curves show the altered spline function (the new centerline of the bifurcation to be).

The right panels represent the B-spline coefficients, the grey bars stand for the coefficients being returned by the interpolation (i.e. the best fits that can model the arteries), whereas the black bars represent the coefficients being modified according to a certain strength parameter, i.e. multiplied by some weights (here, the weight was set to 5 for the upper panels, and 15 in the lower panels).

Precisely, the weights are applied as follows: To the initial B-Spline coefficients (grey bars in FIG. 4) the system 10 adds a random value (within the range

$$[ - \frac{1}{2} , \frac{1}{2} ] )$$

multiplied by the weights (for instance, in the range [5, 20], which showed reasonable geometric distortions).

According to another embodiment, the B-Spline coefficients are the result of the multiplication of the initial B-Spline coefficient by a constant, the constant being superior to 1.

For instance, the constant is such that the modifier B-Spline coefficient is equal to the initial B-Spline coefficient plus X % of the initial B-Spline coefficient, X being comprised between 5% and 30%.

For the third example corresponding to the noise model, the standard deviation is changed from a first value σ₀ to a second value σ_{f}.

For this, the system 10 applies a Gaussian filter with a filter standard deviation σ_{G} is applied on the real image. The filter standard deviation σ_{G} depends from the first value σ₀ and the second value σ_{f}.

More precisely, in the present example, the filter standard deviation σ_{G} depends from the first value σ₀ and the second value σ_{f} by the following relation:

$${σ}_{G} \approx \frac{{σ}_{0}}{2 {σ}_{f} \sqrt{π}}$$

The fact that such value enables to obtained the desired second value σ_{f} can be justified as follows.

When going through Gaussian blur, the input image I(x, y) is filtered as follows:

$$O ( x , y ) = {\sum }_{t = ∞}^{∞} {\sum }_{j = ∞}^{∞} \frac{1}{2 π {σ}_{G}^{2}} {e}^{- \frac{{i}^{2} + {j}^{2}}{2 {σ}_{G}^{2}}} I ( x + i , y + j )$$

The Bienaymé's identity states that:

$$Var ( {\sum }_{i = 1}^{n} {X}_{i} ) = {\sum }_{i = 1}^{n} Var ( {X}_{i} ) + {\sum }_{i , j = 1 , i \neq j}^{n} Corr ( {X}_{i} , {X}_{j} )$$

Thus, the variance of a linear combination is:

$$Var ( {\sum }_{i = 1}^{n} {c}_{i} {X}_{i} ) = {\sum }_{i = 1}^{n} {c}_{i}^{2} Var ( {X}_{i} ) + {\sum }_{i , j = 1 , i \neq j}^{n} {c}_{i} {c}_{j} Corr ( {X}_{i} , {X}_{j} )$$

However, if Xᵢ, . . . , Xₙ are pairwise independent integrable random variables, namely

$$Corr ( {X}_{i} , {X}_{j} ) = 0 , ∀ ( i \neq j )$$

which consider as true in the following, then:

$$Var ( {\sum }_{i} {c}_{i} {X}_{i} ) = {\sum }_{i} {c}_{i}^{2} Var ( {X}_{i} )$$

where cᵢ are constants.

Therefore, the variance of the input image is:

$$Var [ I ( x + i , y + j ) ] = {σ}_{0}^{2}$$

The goal here is to estimate the variance of the output (filtered) image

$$Var [ I ( x + i , y + j ) ] = {σ}_{f}^{2}$$

Thus,

$${σ}_{f}^{2} = {σ}_{0}^{2} = {( {\sum }_{t = ∞}^{∞} {\sum }_{j = ∞}^{∞} \frac{1}{2 π {σ}_{G}^{2}} {e}^{- \frac{{i}^{2} + {j}^{2}}{2 {σ}_{G}^{2}}} )}^{2}$$

For large σ_{G}, the squared Gaussian is smooth and the sum can be approximated as:

$${σ}_{f}^{2} \approx {σ}_{0}^{2} = {\int }_{- ∞}^{∞} {\int }_{- ∞}^{∞} {( \frac{1}{2 π {σ}_{G}^{2}} {e}^{- \frac{{i}^{2} + {j}^{2}}{2 {σ}_{G}^{2}}} )}^{2} di . dj = \frac{{σ}_{0}^{2}}{4 π {σ}_{G}^{2}}$$

and thus,

$${σ}_{f} \approx \frac{{σ}_{0}}{2 {σ}_{G} \sqrt{π}}$$

In summary, when an image composed of Gaussian noise of standard deviation σ₀ is being filtered by a Gaussian filter of standard deviation σ_{G}, the so-obtained filtered image has a standard deviation of σ_{f} according to the previous equation.

For the fourth example with the background model, one can vary the areas by a geometrical deformation.

There again, it can easily be understood that any combination of the modifications described previously can be considered.

At the end of the step of modifying, the system 10 obtains an image based on the same model than the real image but with different parameters.

In some cases, this synthetic image can be improved by a correcting step.

For instance, it may happen that the extremity of the branch located onto the bifurcation may be slightly shifted away from the other two arteries; in other words, at the bifurcation node, any of the three arteries might not connect any longer with the others, the system 10 deals with this issue by simply locating the new extremity coordinates and by shifting the whole set of coordinates back toward the center.

At the end of the phase of generating, it is thus obtained a set of synthetic images. Such set can comprise a quite large number of synthetic images thanks to the easiness of change of one or several value(s) of the parameters of the imaging model.

The phase of training is a phase of training a recognition predictor adapted to obtain bifurcation recognition data in an input image.

This enables to obtain a trained recognition predictor.

Here, the trained recognition predictor is adapted to determine whether the bifurcation belongs to one kind of bifurcations of interest and to indicate which one.

The recognition predictor is, for instance, a neural network.

Notably, the neural network can be a tridimensional convolutional neural network, such as a U-net network.

This enables to obtain a trained recognition predictor.

The phase of training comprises a step of forming and a step of training.

During the step of forming, the system 10 forms a training dataset based on the synthetic images.

Such formation can be made by using only synthetic images or can be added to a dataset from with real images; For instance, the system 10 selects randomly synthetic images among all the synthetic images to form the training dataset.

The annotation can be obtained by obtaining the value from the model.

This enables to generate a training dataset, which is automatically annotated.

During the step of training, the system 10 trains the recognition predictor by using the training dataset according to any unsupervised learning technique.

The system 10 thus obtains a trained recognition predictor.

During the phase of inferring, the system 10 receives a real image to be analyzed, the real image to be analyzed being an image of the vascular tree of the subject.

The image is for instance taken by a MRA-TOF technique.

The system 10 then applies the trained recognition predictor on the image to be analyzed to obtain bifurcation recognition data.

The present method thus corresponds to a full synthetic model for 3D cerebral arteries and bifurcations. By building this model, the goal is to provide a substantial dataset of brain arteries which could be used by a 3D Neural Network to either segment or detect/recognize some constituents of the cerebral vasculature.

The method enables to reduce as much as can be, or even possibly to free oneself from any manual labelling. In other words, using thousands or tens hundreds of thousands of modeled bifurcation to train a recognition predictor might provide better performances that using only about one or two hundred actual TOF segmentations. Especially because there is a significant variability among the anatomical structure of the vasculatures.

For this, the data augmentation carried out here is not naïve because a naïve data augmentation might tamper with the geometrical or statistical properties in an undesirable way, i.e. render the augmented images too distant from their ground truth. Hence, the proposed data augmentation is rendered smart by the use of a specific model.

It should also be noted that such effect is obtained independently from the nature of the bifurcation recognition data. This implies that the predictor can be adapted to predict other data.

In particular, the bifurcation recognition data can here be chosen among the following elements:
the presence of the bifurcation,
the location of the bifurcation,
the bifurcation angle of the bifurcation: the bifurcation angle can be defined as the combination of two angles which will be named [symbol] and [symbol] in FIG. 3. The first angle [symbol] is the angle between the mother artery and the first artery while the second angle [symbol] is the angle between the mother artery and the second artery,
the geodesic distance between two bifurcations: by definition, the geodesic distance between two consecutive bifurcations is the geodesic distance of the centers of the two bifurcations. The geodesic distance between two points of a bifurcation is the length of the path followed in the graph to join both, that is the number of voxels between these two points,
the cross-section area of the detected bifurcation, and
the tortuosity parameter of the bifurcation.

Therefore, the method for recognizing is an accurate method for obtaining bifurcation recognition data.

This has been confirmed by experiments carried out by the Applicant.

Many applications of this method for recognizing can be considered. Some of them are developed hereinafter.

Are notably developed the applications linked to aneurysm. When relevant, the applications are in vitro applications.

A first example of application is a method for predicting.

For this application, it is proposed a method for predicting that a subject is at risk of developing an aneurysm.

The method for predicting comprises a step for carrying out the steps of the method for recognizing, to obtain bifurcation recognition data.

The method for predicting also comprises a step of predicting that the subject is at risk of developing an aneurysm based on the obtained data.

A second example of application is a method for diagnosing.

This application corresponds to a method for diagnosing an aneurysm to a subject.

The method for diagnosing comprises carrying out the steps of the method for recognizing, to obtain bifurcation recognition data.

The method for diagnosing also comprises carrying out a step of diagnosing aneurysm based on the obtained data.

A third example of application is a method for treating.

This application corresponds to a method for treating an aneurysm.

The method for treating comprises carrying out the steps of the method for recognizing, to obtain bifurcation recognition data.

The method for treating also comprises carrying out a step of administrating a medicine treating the aneurysm determined based on the obtained data.

A fourth example of application is a method for identifying a therapeutic target.

This application corresponds to a method for identifying a therapeutic target for preventing and/or treating an aneurysm.

The method for identifying comprises carrying out the steps of the method for recognizing at least one bifurcation of a vascular tree of a first subject, to obtain first bifurcation recognition data, the first subject being a subject suffering from an aneurysm.

The method for identifying also comprises carrying out the steps of the method for recognizing at least one bifurcation of a vascular tree of a second subject, to obtain second bifurcation recognition data, the second subject being a subject not suffering from an aneurysm.

The method for identifying further comprises a step of selecting a therapeutic target based on the comparison of the first bifurcation recognition data and the second bifurcation recognition data.

A fifth example of application is a method for identifying a biomarker.

The biomarker can be one biomarker among a diagnostic biomarker of aneurysm, a susceptibility biomarker of aneurysm, a prognostic biomarker of aneurysm or a predictive biomarker in response to the treatment of aneurysm.

The method for identifying comprises carrying out the steps of the method for recognizing at least one bifurcation of a vascular tree of a first subject, to obtain first bifurcation recognition data, the first subject being a subject suffering from an aneurysm.

The method for identifying comprises carrying out the steps of the method for recognizing at least one bifurcation of a vascular tree of a second subject, to obtain second bifurcation recognition data, the second subject being a subject not suffering from an aneurysm.

The method for identifying comprises selecting a biomarker based on the comparison of the first bifurcation recognition data and the second bifurcation recognition data.

A sixth example of application corresponds to a method for screening a compound.

The medicine has an effect on a known therapeutical target, for preventing and/or treating an aneurysm.

The method for screening comprises carrying out the steps of the method for recognizing at least one bifurcation of a vascular tree of a first subject, to obtain first bifurcation recognition data, the first subject being a subject suffering from aneurysm and having received the compound.

In this context, the term “receive” encompasses any ways of administration of the medicine.

The method for screening also comprises carrying out the steps of the method for recognizing at least one bifurcation of a vascular tree of a second subject, to obtain second bifurcation recognition data, the second subject being a subject suffering from the aneurysm and not having received the compound.

The method for screening further comprises selecting a compound based on the comparison of the first bifurcation recognition data and second bifurcation recognition data.

1. A method for recognizing at least one bifurcation of a vascular tree in a real image of a vascular tree of a subject, notably a cerebral one, the method being computer-implemented, the method comprising:
a phase of generating synthetic images of at least one bifurcation of a vascular tree, the phase of generating comprising, for each synthetic image, the steps of:
receiving a real image comprising at least one bifurcation of a vascular tree,
modeling the real image by an imaging model with a specific set of values for a set of parameters, the imaging model comprising at least a geometrical model of the bifurcation,
the geometrical model being a tridimensional model of the bifurcation and including a graph of the vascular tree, the graph being a set of nodes linked by branches with a weight, the geometrical model being obtained by segmenting the real image,
generating the image corresponding to the imaging model with a modified set of values, the generated image being the synthetic image,
a phase of training a recognition predictor adapted to obtain bifurcation recognition data in an input image, to obtain a trained recognition predictor, the phase of training comprising the steps of:
forming a training dataset based on the synthetic images, and
training the recognition predictor by using the training dataset, and
a phase of inferring, the phase of inferring comprising the steps of:
receiving a real image to be analyzed, the real image to be analyzed being an image of the vascular tree of the subject, and
applying the trained recognition predictor on the image to be analyzed to obtain bifurcation recognition data.

2. The method for recognizing according to claim 1, wherein: the imaging model comprises a noise model, the noise model modelling the noise of the image by a Gaussian noise with a standard deviation, the standard deviation of the Gaussian noise being one of the parameters of the model, the standard deviation being equal to a first value,
during the step of generating, a Gaussian filter with a standard deviation is applied on the real image to obtain an image with a Gaussian noise with a standard deviation having a second value, the second value being different from the first value, the standard deviation of the Gaussian filter depending from the first value and the second value.

3. The method for recognizing according to claim 1, wherein the parameters of geometrical model further include the diameters of the bifurcation, the values of the diameters being obtained by applying a convolution kernel on the real image.

4. The method for recognizing according to claim 1, wherein, during the step of generating, a geometrical distortion is applied to the geometrical model.

5. The method for recognizing according to claim 1, wherein the geometrical model defines reference points for the bifurcation, the geometrical model comprising interpolating functions linking the reference points, each interpolating function being a function defined by coefficients, the coefficients being parameters of the set of parameters, the coefficients being modified during the step of generating.

6. The method for recognizing according to claim 5, wherein each interpolating function is a B-spline function defined by B-spline's coefficients and the coefficients are the B-spline's coefficients.

7. The method for recognizing according to claim 5, wherein the values of the coefficients are modified by adding a random value multiplied by a weight to the specific value.

8. The method for recognizing according to claim 1, wherein the imaging model includes a background model, the background model comprising a shape with two distinct values.

9. The method for recognizing according to claim 1, wherein each image is taken by a MRA-TOF technique.

10. The method for recognizing according to claim 1, wherein the bifurcation recognition data are chosen among the following elements:
the class or the type of bifurcation,
the presence of the bifurcation,
the location of the bifurcation,
the bifurcation angle of the bifurcation,
the geodesic distance between two bifurcations,
the cross-section area of the detected bifurcation, and
the tortuosity parameter of the bifurcation.

11. The method for recognizing according to claim 1, wherein the recognition predictor is a neural network.

12. The method for recognizing according to claim 11, wherein the neural network is a convolutional neural network.

13. A method comprising carrying out the steps of a method for recognizing at least one bifurcation of a vascular tree in a real image of a vascular tree of a subject, the method being according to claim 1, the method being chosen in the list consisting of
a method for predicting that a subject is at risk of developing an aneurysm, the method for predicting at least comprising the step of:
carrying out the steps of the method for recognizing, to obtain bifurcation recognition data,
predicting that the subject is at risk of developing the aneurysm based on the obtained bifurcation recognition data,
a method for diagnosing an aneurysm, the method for diagnosing at least comprising the step of:
carrying out the steps of the method for recognizing, to obtain bifurcation recognition data, and
diagnosing the aneurysm based on the obtained bifurcation recognition data,
a method for identifying a therapeutic target for preventing and/or treating an aneurysm, the method comprising at least the step of:
carrying out the steps of the method for recognizing to a first subject, to obtain first obtained bifurcation recognition data, the first subject being a subject suffering from the aneurysm,
carrying out the steps of the method for recognizing to a second subject, to obtain obtained bifurcation recognition data, the second subject being a subject not suffering from the aneurysm, and
selecting a therapeutic target based on the comparison of the first and second obtained bifurcation recognition data,
a method for identifying a biomarker, the biomarker being a diagnostic biomarker of an aneurysm, a susceptibility biomarker of an aneurysm, a prognostic biomarker of an aneurysm or a predictive biomarker in response to the treatment of an aneurysm, the method comprising at least the step of:
carrying out the steps of the method for recognizing to a first subject, to obtain first obtained bifurcation recognition data, the first subject being a subject suffering from the aneurysm,
carrying out the steps of the method for recognizing to a second subject, to obtain second obtained bifurcation recognition data, the second subject being a subject not suffering from the aneurysm, and
selecting a biomarker based on the comparison of the first and second determined parameters,
and
a method for screening a compound useful as a probiotic, a prebiotic or a medicine, the compound having an effect on a known therapeutical target, for preventing and/or treating an aneurysm, the method comprising at least the step of:
carrying out the steps of the method for recognizing to a first subject, to obtain first obtained bifurcation recognition data, the first subject being a subject suffering from the aneurysm and having received the compound,
carrying out the steps of the method for recognizing to a second subject, to obtain second obtained bifurcation recognition data, the second subject being a subject suffering from the aneurysm and not having received the compound, and
selecting a compound based on the comparison of the first and second determined parameters.

14. A computer program product comprising instructions for carrying out the steps of a method according to claim 1 when said computer program product is executed on a suitable computer device.

15. A computer readable medium having encoded thereon a computer program according to claim 14.
